(19) United States
(12) Patent Application Publication
(10) Pub. No.: US 2025/0262032 A1
(43) Pub. Date: Aug. 21, 2025

(54) DENTAL IMPLANT SCREW WITH VARIABLE PROFILE HEAD

(71) Applicant: Dan Rosen, Calabasas, CA (US)

(72) Inventor: Dan Rosen, Calabasas, CA (US)

(21) Appl. No.: 18/444,497

(22) Filed: Feb. 16, 2024

(51) Int. Cl. A61C 8/00

(52) U.S. Cl. CPC A61C 8/0068

(57) ABSTRACT

A dental implant screw apparatus is disclosed for installation in a patient for a releasable, non-binding tightening action against a surface. The apparatus includes a threaded portion configured to engage the surface, and a head portion which is generally conical, extending from a narrow end to wide end, thus having an overall conical side profile with the narrow end near the threaded portion and the wide end away from it. The conical profile has an undulating wave profile. The undulating wave profile constitutes a plurality of troughs and a plurality of peaks running closer to and way from a central axis of the screw, such that the peaks engage the surface, and the plurality of troughs are configured such that they do not engage the surface.

### FIELD OF THE INVENTION

The present invention relates to dental implants and more specifically to a dental implant screw for holding a dental prosthetic.

### BACKGROUND

Dental implants are well known in the art, including dental implants, which generally regarded as the anchoring portion driven into the soft bone of a patient, onto which a prosthetic will be mounted once the implant is solidly healed in the patient, Frequently, implants must be driven at angles oblique to the central axis of a prosthetic, due to considerations of sufficient anchorage. An implant may have to be driven at one angle to be securely held in place by the patient's bone, while the prosthetic must be generally held at a different angle. For this reason, a multi-unit abutment is frequently used.

A multi-unit abutment is used to change the angle from the implant to the prosthetic. The multi-unit abutment engages the implant in a threaded arrangement, typically having a hex pattern or similar structure at the bottom so that it cannot rotate relative to the implant. A screw is driven through the multi-unit abutment to hold it fast against the implant. The multi-unit abutment has another screw bore on its top surface and a top mounting surface for a dental prosthetic. Once the prosthetic is mounted on the multi-unit abutment, another dental screw is inserted through the prosthetic, tightening the prosthetic against the multi-unit abutment. Due to the difference in angle between the implant and the prosthetic, the top multi-unit abutment can accommodate two screws.

Dental implant screws engaging the multi-unit abutment through the prosthetic have been developed with conical heads. A smooth conical head presents a side surface having maximal engagement with the prosthetic, or against a sleeve embedded in the prosthetic, either of which have a complimentary conical profile. This presents several problems. First, a smoothly conical head may have such pronounced pressure under full contact that it essentially binds against the prosthetic or sleeve and cannot be removed. This requires further drilling and undesirable remedial measures. This is particularly true when using polymethyl-methacrylate (PMMAA) or other very hard materials creating a wedging effect.

Another problem, particularly with conical head dental screws driven directly into prosthetics is the pressures against the prosthetic may cause it to crack. This is particularly likely when using a brittle material. Additionally, a conventional conical head dental screw typically comes to a sharp angle where the conical side of the head meets the top surface of the head. This can make controlling the screw and moving it around corners difficult, which exacerbates the wedging effect discussed above.

For these reasons it is an object of the present invention to provide a conical implant screw that avoids binding or otherwise wedging against a complimentary conical profile when installed in a dental prosthetic. Another object is to provide a dental screw that can be manipulated at oblique angles by a driving tool. Yet another object is to provide a dental screw that can easily be manipulated around corners during installation in a patient. These and other objects are more fully described in the following specification and drawings.

### SUMMARY

A dental implant screw apparatus is disclosed for installation in a patient and configured for a releasable, non-binding tightening action against a surface, such as at an implant site on a dental patient. The apparatus includes a threaded portion configured to engage a top portion of a dental implant, such as a multi-unit abutment, in a helically tightened configuration. A head portion is also provided. The head portion is generally conical, extending from a narrow end to wide end, and thus has an overall conical side profile. Preferably, the narrow end of the generally conical profile is proximal to the threaded portion, while the wide end of the side profile is distal from the threaded portion.

The generally conical profile comprises an undulating wave profile. The undulating wave profile constitutes a plurality of troughs and a plurality of peaks running closer to and way from a central axis of the screw. The plurality of peaks is configured such that they simultaneously engage the surface, and the plurality of troughs are configured such that they do not engage the surface, while the plurality of peaks is configured, simultaneously, to engage the surface.

In one embodiment, the undulating wave profile comprises a uniform plurality of troughs and plurality of peaks. In another embodiment, the plurality of troughs and the plurality of peaks may vary in size. In yet another embodiment, the plurality of troughs and the plurality of peaks are larger in size proximal the wide end and smaller in size proximal the narrow end. In yet another embodiment, the plurality of peaks are wider than the plurality of troughs. In still another contemplated embodiment, the plurality of troughs are wider than the plurality of peaks.

The implant screw terminates at the wide end, distal from the threaded portion, having a rounded shoulder. In one preferred embodiment, the rounded shoulder comprises an arc larger than the curvature of the plurality of troughs and the plurality of peaks. The wide end terminates at a bore. In one embodiment, the bore is located inward of the rounded shoulder. In one preferred embodiment, the interface between the rounded shoulder and the bore comprises the farthest extent of the head portion away from the threaded portion of the implant screw. The rounded shoulder may be so pronounced that the head of the implant screw is a rounded dome with a bore in the center.

The bore preferably comprises a drive socket. In one preferred embodiment, the drive socket may comprise a lobular and fluted star-shaped pattern for driving by a star-shaped bit on a tightening device. In one preferred embodiment, the lobes and flutes of the star-shaped pattern are rounded. In another preferred embodiment, the bore extends into the head portion, terminating in a conical bottom portion below the star-shaped pattern.

The threaded portion has a cylindrical profile, in contrast to the conical head portion. In some embodiments, the implant screw may comprise a middle collar located between the threaded portion and the head portion. In one embodiment the middle collar may be smooth across its surface. The middle collar can be made of any size, depending on the fit of the implant screw in other hardware components related to the implant.

In an alternative embodiment, a dental implant screw apparatus is disclosed for installation in a patient, in a prosthetic dental workpiece. The apparatus is configured for a non-binding tightening action against the prosthetic. The apparatus includes a threaded portion configured to engage a top portion of a dental implant, such as a multi-unit abutment, in a helically tightening configuration, and a head portion. Like the first embodiment, the head portion has a generally conical, narrow end extending toward a wide end, thereby creating a conical side profile.

The narrow end of the generally conical profile is proximal to the threaded portion, while the wide end of the side profile is distal from the threaded portion. The conical profile of the head portion is complimentary to a conical receptacle of the prosthetic.

The generally conical profile comprises an undulating wave profile comprising a plurality of troughs and a plurality of peaks. The plurality of peaks is configured such that they simultaneously engage the prosthetic, and the plurality of troughs are configured such that they do not engage the surface when the plurality of peaks engage the surface. In this embodiment, the prosthetic may further include a sleeve for engaging the implant screw, and the sleeve may comprise the conical receptacle of the prosthetic for the head portion of the implant screw.

In another alternative embodiment, a dental implant screw apparatus is provided for installation in a patient in a prosthetic using a multi-unit abutment. The apparatus is configured for a non-binding tightening action against the prosthetic. The apparatus includes a threaded portion configured to engage a top portion of a dental implant in a helically tightening configuration. A head portion is provided. The head portion includes a generally conical, narrow end to wide end, side profile. The narrow end of the generally conical profile is proximal to the threaded portion and the wide end of the side profile is distal from the threaded portion. The conical profile is complimentary to a conical receptacle of the prosthetic.

The generally conical profile of this third embodiment also comprises an undulating wave profile comprising a plurality of troughs and a plurality of peaks. The plurality of peaks is configured such that they simultaneously engage the prosthetic. The plurality of troughs is configured such that they do not engage the surface when the plurality of peaks engages the surface. The prosthetic joins the multi-unit abutment when the plurality of peaks engages the conical receptacle of the prosthetic.

### BRIEF DESCRIPTION OF THE FIGURES

FIG. 1 illustrates a side view of a dental implant screw having a variable profile head.

FIG. 2 illustrates a top end view of the dental implant screw having a variable profile head.

FIG. 3 illustrates a perspective view of the dental implant screw having a variable profile head.

FIG. 4 illustrates a side elevation view of the dental implant screw having a variable profile head installed in a multi-unit abutment.

FIG. 5 illustrates a side elevation view of the dental implant screw having a variable profile head installed in a sleeve to which a prosthetic may be mounted.

### DESCRIPTION

The present invention is described more fully hereinafter, but not all embodiments are shown. While the invention has been described with reference to exemplary embodiments, it will be understood by those skilled in the art that various changes may be made, and equivalents may be substituted for elements thereof without departing from the scope of the disclosure. In addition, many modifications may be made to adapt a particular structure of material to the teachings of the disclosure without departing from the essential scope thereof.

The drawings accompanying the application are for illustrative purposes only. They are not intended to limit the embodiments of the present application. Additionally, the drawings are not drawn to scale. Common elements between different figures may retain the same numerical designation.

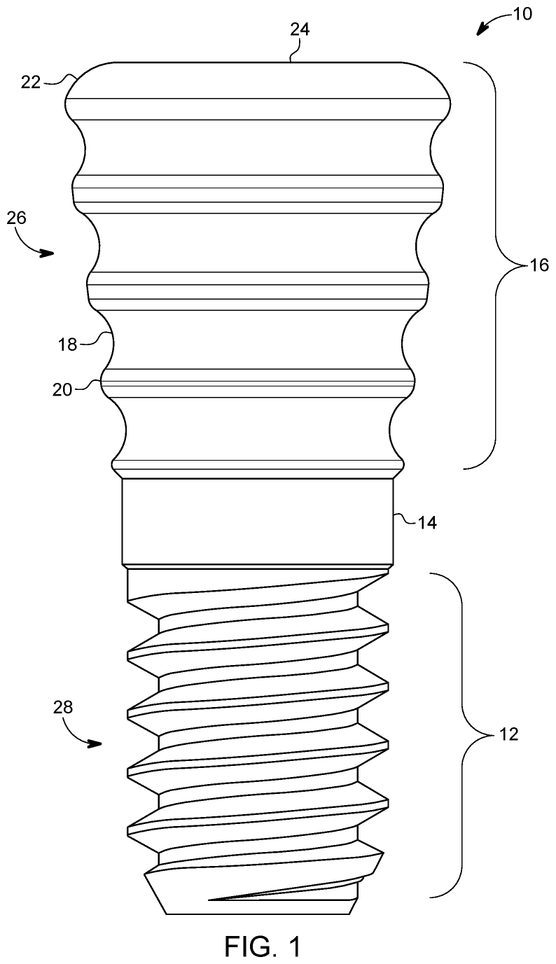

Referring to FIG. 1, an implant screw 10 is provided for securing a dental prosthetic to a dental implant. Such implants may include a multi-unit abutment (MUA) or similar angled structure. The implant screw 10 avoids the necessity of employing a tibase. The implant screw has three primary zones: a threaded portion 12 for interfacing with a dental implant (not shown), a middle collar 14, and a head portion 16 which engages the prosthetic. In some embodiments the middle collar 14 may be omitted or may be configured as a larger or smaller middle collar according to preference.

Still referring to FIG. 1, the head portion 16 is characterized by a variable profile, in which the head portion 16 comprises a series of undulating troughs 18 and peaks 20. The troughs 18 and peaks 20 terminate at the middle collar 14 (or threaded portion 12) and at a shoulder 22 at the top 24 of the implant screw 10. The troughs 18 and peaks 20 make up a profile angled portion 26, which differs from the threaded portion 12, which has a straight profile 28. The sidewall 20 is conical in its overall profile, but the profile angled portion 26 comprises the undulating pattern of troughs 18 and peaks 20, such that only each peak 20 of the head portion 16 comes into contact with the prosthetic, or the prosthetic sleeve.

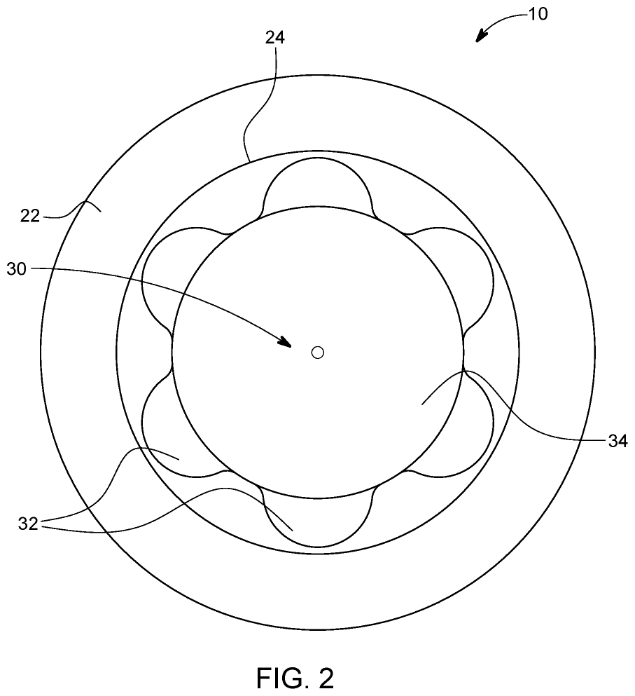

Referring to FIG. 2, the implant screw 10 is shown from above. The broad shoulder 22 of the implant screw 10 surrounds the top 24, which represents the apex of the implant screw 10. The shoulder 22 and the top 24 surround a bore 30 extending into the implant screw 10 from above, enabling a user to drive the implant screw 10 into a dental implant, MUA, or other structure. The bore 30 is surrounded by a series of drive sockets 32. In the illustrated embodiment, the bore 30 and drive sockets 32 form a TORX® screw drive characterized by a six-point star shaped pattern. The star-shaped drive is important since a user may be engaging the implant screw 10 from off-angle, and the star-shaped drive resists a driver camming out of the implant screw 10 at an angle or under excessive torque. This design allows for a higher torque to be exerted than a hex socket head without damaging the implant screw 10 or the tool driving it. Below the drive sockets, a conical bottom portion 34 is provided to the bore 30.

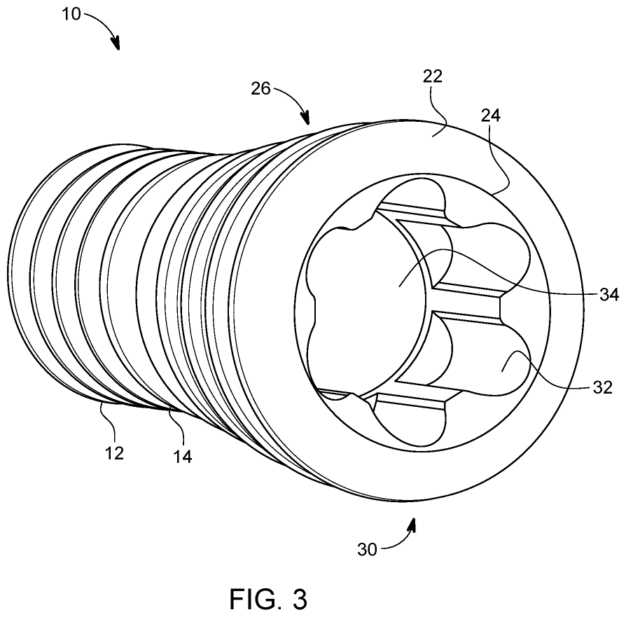

Referring to FIG. 3, the implant screw 10 is shown in perspective view, including the straight threaded portion 12 and middle collar 14 and the profile angled portion 26 (i.e., the head portion 16 as shown in FIG. 1), which terminates at the shoulder 22, and top 24 of the implant screw 10. The bore 30 is also shown with the drive sockets 32 at an angle to demonstrate their length relative to the length of the bore, and to show that the drive sockets are angled downward relative to the top 24 of the implant screw 10. This is an important feature that facilitates a user driving the implant screw 10 from off-angle when installing a prosthetic in a patient. The conical bottom portion 34 of the bore 30 is also shown in perspective view to show its angle in relation to the bore 30.

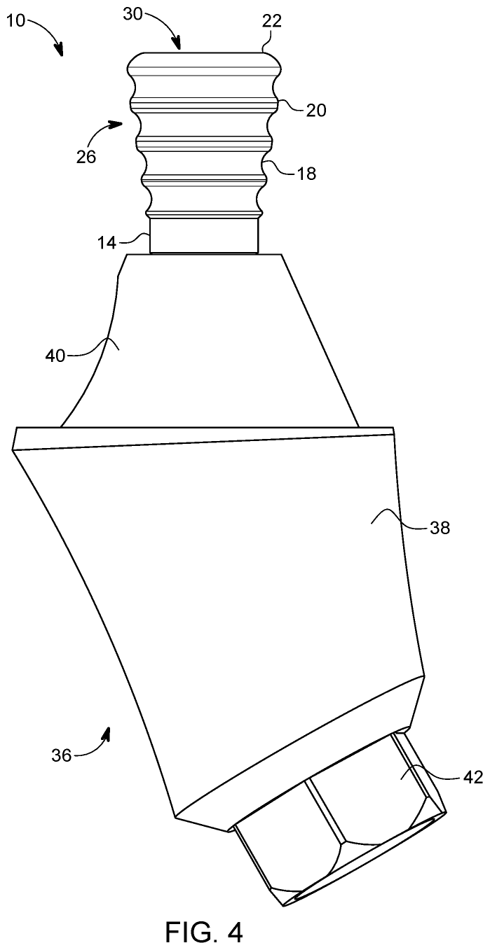

Referring to FIG. 4, the implant screw 10 is shown affixed to a multi-unit abutment (MUA) 36. In this view the threaded portion 12 has been driven into the MUA 36 which has an open threaded bore (not shown) at the top of a prosthetic seat 40. In one embodiment, the middle collar 14 may serve as a stop to prevent the implant screw 10 from being driven too far into the MUA 36. In another embodiment, the MUA open threaded bore may be sized to allow only the threaded portion 12 of the implant screw 10 to be inserted therein.

The MUA 36 includes a main body portion 38 for angling the implant screw 10 relative to the patient's implant. The prosthetic seat 40 is designed to accommodate a prosthetic implant (not shown) held in place by the implant screw 10. The MUA 36 also preferably includes an implant interface 42 for engaging the implant in a way that prevents the MUA 36 from turning relative to the implant. In the illustrated embodiment, a hex implant interface 42 is shown, but it is to be understood that in alternative contemplated embodiments, the implant interface 42 may be of any shape other than round to prevent the MUA 36 from turning relative to the implant.

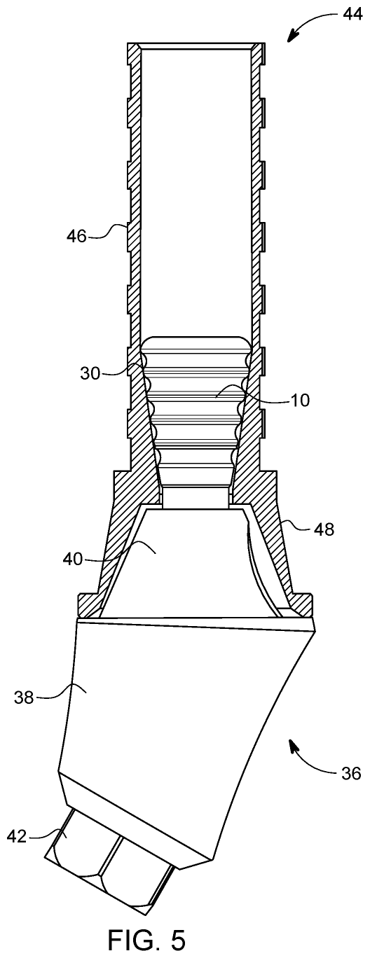

Referring to FIG. 5, the implant screw 10 installed in the MUA 36 is shown attached to a sleeve 44. The sleeve may be employed in instances where the implant screw 10 does not directly engage a prosthetic when installed. The sleeve 44 includes a prosthetic gripping surface 46 which his hollow, and a conical portion 50 in which the implant screw 10 seats. The sleeve 44 also includes an MUA interface portion 48 for engaging the prosthetic seat 40 of the MUA 36 in a way that preferably ensures a solid, uniform connection all the way around the prosthetic seat 40 of the MUA 36.

Still referring to FIG. 5, the implant screw 10 engages the sleeve 44 once it is in position on the MUA 36. When the threaded portion 12 is fully inserted into the MUA 36, the head portion 16 of the implant screw 10 engages the conical portion 50 of the sleeve 50 such that each peak 20 (FIG. 1) of the implant screw 10 is physically engaging the sleeve 44 while each trough 18 has a space between it and the surface of the sleeve 44 conical portion 50. By having the head portion 16 engage the conical portion 50 only selectively using an undulating head portion 16 sidewall, the implant screw can be securely fastened into place, but avoids tortional binding, which tends to fuse the otherwise conical implant screw 10 head portion 16 to the sleeve 44. It is to be understood that this anti-binding action occurs with respect to an implant screw 10 head portion 16 directly engaging prosthetics made of different materials.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A dental implant screw apparatus for installation in a patient and configured for a non-binding tightening action against a surface, the apparatus comprising;
a threaded portion configured for engagement in a helically tightening configuration;
a head portion, the head portion comprising a generally conical, narrow end to wide end, side profile;
wherein the narrow end of the generally conical profile is proximal to the threaded portion and the wide end of the side profile is distal from the threaded portion;
wherein the generally conical profile comprises an undulating wave profile comprising a plurality of troughs and a plurality of peaks; and
wherein the plurality of peaks is configured such that they simultaneously engage the surface, and the plurality of troughs are configured such that they do not engage the surface when the plurality of peaks engage the surface.

2. The apparatus of claim 1 wherein the undulating wave profile comprises a uniform plurality of troughs and plurality of peaks.

3. The apparatus of claim 1 wherein the pluralities of troughs and peaks vary in size.

4. The apparatus of claim 1 wherein the plurality of troughs and the plurality of peaks are larger in size proximal the wide end and smaller in size proximal the narrow end.

5. The apparatus of claim 1 wherein the plurality of peaks is wider than the plurality of troughs.

6. The apparatus of claim 1 wherein the plurality of troughs is wider than the plurality of peaks.

7. The apparatus of claim 1 wherein the wide end comprises a rounded shoulder.

8. The apparatus of claim 7 wherein the rounded shoulder comprises an arc larger than the curvature of the plurality of troughs and the plurality of peaks.

9. The apparatus of claim 1 wherein the wide end terminates in a bore.

10. The apparatus of claim 9 wherein the bore comprises a drive socket.

11. The apparatus of claim 10 wherein the drive socket comprises a lobular and fluted star-shaped pattern.

12. The apparatus of claim 11 wherein the lobes and flutes of the star-shaped pattern are rounded.

13. The apparatus of claim 11 wherein the bore extends into the head portion, terminating in a conical bottom portion below the star-shaped pattern.

14. The apparatus of claim 1 wherein the threaded portion has a cylindrical profile.

15. The apparatus of claim 1 further comprising a middle collar between the threaded portion and the head portion.

16. The apparatus of claim 15 wherein the middle collar is smooth across its surface.

17. A dental implant screw apparatus for installation in a patient in a prosthetic, the apparatus configured for a non-binding tightening action against the prosthetic, the apparatus comprising;
a threaded portion configured for a helically tightening engagement;
a head portion, the head portion comprising a generally conical, narrow end to wide end, side profile;
wherein the narrow end of the generally conical profile is proximal to the threaded portion and the wide end of the side profile is distal from the threaded portion;
wherein the conical profile is complimentary to a conical receptacle of the prosthetic;
wherein the generally conical profile comprises an undulating wave profile comprising a plurality of troughs and a plurality of peaks; and
wherein the plurality of peaks is configured such that they simultaneously engage the prosthetic and the plurality of troughs are configured such that they do not engage the surface when the plurality of peaks engage the surface.

18. The apparatus of claim 17 wherein the prosthetic further comprises a sleeve.

19. The apparatus of claim 18 wherein the sleeve comprises the conical receptacle of the prosthetic.

20. A dental implant screw apparatus for installation in a patient in a prosthetic using a multi-unit abutment, the apparatus configured for a non-binding tightening action against the prosthetic, the apparatus comprising;
a threaded portion configured to engage a top portion of the multi-unit abutment in a helically tightening configuration;
a head portion, the head portion comprising a generally conical, narrow end to wide end, side profile;
wherein the narrow end of the generally conical profile is proximal to the threaded portion and the wide end of the side profile is distal from the threaded portion;
wherein the conical profile is complimentary to a conical receptacle of the prosthetic;
wherein the generally conical profile comprises an undulating wave profile comprising a plurality of troughs and a plurality of peaks;
wherein the plurality of peaks is configured such that they simultaneously engage the prosthetic and the plurality of troughs are configured such that they do not engage the surface when the plurality of peaks engage the surface; and
wherein the prosthetic joins the multi-unit abutment when the plurality of peaks engages the conical receptacle of the prosthetic.
